(19) United States
(12) Patent Application Publication
(10) Pub. No.: US 2016/0299630 A1
(43) Pub. Date: Oct. 13, 2016

(54) HYBRID TOUCH SENSING ELECTRODE AND TOUCH SCREEN PANEL COMPRISING SAME

(71) Applicant: DONGWOO FINE-CHEM CO., LTD., Jeollabuk-do (KR)

(72) Inventors: Dong Pil PARK, Incheon (KR); Min Soo YANG, Gyeonggi-do (KR); Jae Hyun LEE, Gyeonggi-do (KR); Cheol Hun LEE, Gyeonggi-do (KR)

(21) Appl. No.: 15/038,085

(22) PCT Filed: Nov. 17, 2014
(86) PCT No.: PCT/KR2014/011036

§ 371 Date: May 20, 2016

(30) Foreign Application Priority Data
Nov. 20, 2013 (KR) 10-2013-0141671
Nov. 17, 2014 (KR) 10-2014-0159979

(51) Int. Cl. G06F 3/041; G06F 3/044

(52) U.S. Cl. CPC G06F 3/0418; G06F 3/044; G06F 3/0412; G06F 2203/04102; G06F 2203/04103; G06F 2203/04112; G06F 2211/902

(57) ABSTRACT

Disclosed are a hybrid touch sensing electrode including first sensing patterns adhered to a first optical functional layer, and second sensing patterns adhered to a second optical functional layer, wherein the first and second optical functional layers have a dielectric constant/thickness value of 0.01 to 0.09 1/μm, respectively, and a sum of the dielectric constants of the first and second optical functional layers is 6 to 11, and thereby, the touch sensing electrode may be formed in a thin film structure with improved touch sensitivity while having reduced noise, as well as a touch screen panel including the same.

### BACKGROUND OF THE INVENTION

1. Field of the Invention

The present invention relates to a hybrid touch sensing electrode and a touch screen panel including the same, and specifically, to a hybrid touch sensing electrode that can be applied to a flexible display and a touch screen panel including the same.

2. Description of the Related Art

Commonly, a touch screen is a screen equipped with a special input device to receive position input by touching the screen with a finger of a user or a stylus pen. Such a touch screen does not use a keyboard but has a configuration of multi-layer laminates wherein, when the finger of the user or an object such as a touch pen or a stylus pen touches a specific character or position displayed on a screen, the touch screen identifies the position and directly receives data from the screen, in order to practically process information at a specific position by a software stored therein.

In order to recognize the touched position without degrading the visibility of an image displayed on the screen, it is necessary to use a transparent sensing electrode in which sensing patterns are formed in a predetermined pattern in general.

As a transparent sensing electrode used in the touch screen panel, various structures are known in the related art. For example, a glass-ITO film-ITO film (GFF), a glass-ITO film (G1F), or a glass only (G2) structure may be used in the touch screen panel.

For example, as a conventional transparent sensing electrode, there is a structure illustrated in FIG. 1.

The transparent sensing electrode may be formed by first sensing patterns 10 and second sensing patterns 20. The first and second sensing patterns 10 and 20 are disposed in different directions from each other to provide information on X and Y coordinates of a touched point. Specifically, when the finger of the user or the object touches a transparent substrate, a change in capacitance depending on a contact position is detected and transferred to a driving circuit through the first and second sensing patterns 10 and 20, and a metal wiring which is a position detecting line. Then, the change in capacitance is converted to an electrical signal by X and Y input processing circuits (not illustrated) to identify the contact position.

In this regard, the first and second sensing patterns 10 and 20 have to be formed in the same layer of the transparent substrate, and the respective patterns have to be electrically connected with each other to detect the touched position. However, the second sensing patterns 20 are connected with each other while the first sensing patterns 10 are separated from each other in an island form, thereby additional connection electrodes (bridge electrodes) 50 are needed to electrically connect the first sensing patterns 10 with each other.

However, the connection electrodes 50 should not be electrically connected to the second sensing patterns 20, and thus, have to be formed in a layer different from the second sensing patterns 20. In order to show such a structure, FIG. 2 illustrates an enlarged view of a portion in which the connection electrodes 50 are formed in a cross-section taken on line A-A′ of FIG. 1.

Referring to FIG. 2, the first and second sensing patterns 10 and 20 formed on a substrate 1 are electrically insulated from each other by an insulation film 30 formed thereon. In addition, as described above, since the first sensing patterns 10 have to be electrically connected with each other, these patterns are electrically connected with each other by using the connection electrodes 50.

In order to connect the first sensing patterns 10, which are separated in the island form, with each other by the connection electrodes 50 while electrically isolated from the second sensing patterns 20, there is a need to form contact holes 40. For this, after the contact holes 40 are formed in the insulation film 30, there is a need to execute an additional step of forming the connection electrodes 50.

As described above, additional processes for forming the contact holes 40 and the connection electrodes 50 are required in the transparent sensing electrode additionally including such connection electrodes 50, whereby defects such as an electrical short-circuit between the first sensing patterns 10 and the second sensing patterns 20 may occur during manufacturing processes, and electrical conductivity of sensing electrode patterns may be reduced due to a contact resistance between the connection electrodes and the sensing patterns.

In order to solve the above-described problems, Korean Patent Laid-Open Publication No. 2010-84263 discloses a technique in which connection electrodes are firstly formed on a transparent substrate, and then an insulation film and contact holes are formed, and first sensing patterns and second sensing patterns are formed thereon, so as to improve problems in relation with the number of masks and the complexity of the process.

However, the technique disclosed in the Korean Patent Laid-Open Publication No. 2010-84263 may not basically solve the above-described problems, because it should be provided with additional connection electrodes.

Meanwhile, recently, studies into a flexible display which is more thin and lighter than a conventional panel by using a polymer film instead of a glass substrate and can be bent to some degrees are actively conducted.

Such a flexible display may be manufactured in a form of plastic film LCDs, organic ELs, wearable displays, electronic books, electronic paper, or the like, with very wide range of applications. Therefore, the flexible display may also be applied to a product such as a display for a mobile communication terminal, or a display for a portable information communication device, which requires a flexible or various shaped display having high resistance to external shock or vibration, in addition to being thin and light.

On the other hand, in a case of a flexible liquid crystal display, implementation of a display having a thinner thickness is a primary concern. However, for the flexible liquid crystal display, only the material of a currently used substrate is changed from the existing glass substrate to a polymer film, and other peripheral parts such as a polarizing plate, backlight, etc., which are required to implement the display, still use the same material and method as those applied to the glass substrate.

For example, a conventional liquid crystal display includes a polarizing plate having a thickness of 200 to 400 μm, and a protective layer having a thickness of 25 to 100 μm used for protecting a polarizer, and which are a limitation of a decrease in thickness and size. Due to this disadvantage, there is a difficulty to apply the conventional liquid crystal display to a thin film structure such as a card.

In order to solve such a problem, Korean Patent Laid-Open Publication No. 2008-0073252 discloses a technique relating to the flexible liquid crystal display to achieve a thin film structure by omitting a protective film contacting a liquid crystal cell, which is a component of a polarizing plate adhered to the liquid crystal cell.

However, this technique also has a difficulty to apply to a thin type flexible display due to the thickness of components forming the touch sensing electrode.

### SUMMARY OF THE INVENTION

Accordingly, it is an object of the present invention to provide a touch sensing electrode with improved touch sensitivity while having reduced noise.

Another object of the present invention is to provide a hybrid touch sensing electrode which is integrally formed with another optical functional layer of a touch screen panel.

In addition, another object of the present invention is to provide a hybrid touch sensing electrode which does not require an additional bridge electrode.

Further, another object of the present invention is to provide a touch screen panel including the touch sensing electrode having a thin film structure with excellent visibility.

The above object of the present invention will be achieved by the following characteristics:

(1) A hybrid touch sensing electrode including: first sensing patterns adhered to a first optical functional layer, and second sensing patterns adhered to a second optical functional layer, wherein the first and second optical functional layers have a dielectric constant/thickness value of 0.01 to 0.09 1/μm, respectively, and a sum of the dielectric constants of the first and second optical functional layers is 6 to 11.

(2) The hybrid touch sensing electrode according to the above (1), the first optical functional layer has a dielectric constant of 3.2 to 6.0, and the second optical functional layer has a dielectric constant of 2.8 to 5.0.

(3) The hybrid touch sensing electrode according to the above (1), the first optical functional layer has a thickness of 35 to 320 μm, and the second optical functional layer has a thickness of 30 to 280 μm.

(4) The hybrid touch sensing electrode according to the above (1), the first optical functional layer and the second optical functional layer are independently included in the touch screen panel.

(5) The hybrid touch sensing electrode according to the above (1), a dielectric constant/distance value between the first sensing patterns and the second sensing patterns is 0.01 to 0.25 1/μm.

(6) The hybrid touch sensing electrode according to the above (1), a distance between the first sensing patterns and the second sensing patterns is 12 to 300 μm.

(7) The hybrid touch sensing electrode according to the above (1), a dielectric constant between the first sensing patterns and the second sensing patterns is 2.8 to 5.0.

(8) The hybrid touch sensing electrode according to the above (1), the first optical functional layer and the second optical functional layer are each independently selected from a group consisting of a cover window, a polarization plate and a retarder, but are not the same as each other.

(9) The hybrid touch sensing electrode according to the above (8), the polarization plate is a single polarizer layer or a laminate in which a protective film is adhered to at least one surface of the polarizer.

(10) The hybrid touch sensing electrode according to the above (9), the polarizer and the protective film included in the laminate polarization plate are an individual optical functional layer, respectively.

(11) The hybrid touch sensing electrode according to the above (8), the retarder is a single layer or a laminate in which a hardened liquid crystal film is adhered to one surface of a substrate.

(12) The hybrid touch sensing electrode according to the above (11), the substrate and the hardened liquid crystal film included in the laminate retarder are an individual optical functional layer, respectively.

(13) The hybrid touch sensing electrode according to the above (1), the first sensing patterns and the second sensing patterns are formed on different planes from each other.

(14) The hybrid touch sensing electrode according to the above (1), the first sensing patterns and the second sensing patterns are not provided with additional insulation.

(15) The hybrid touch sensing electrode according to the above (1), both of refractive index differences between the first optical functional layer and the first sensing patterns, and between the second optical functional layer and the second sensing patterns are 0.8 or less.

(16) The hybrid touch sensing electrode according to the above (1), the sensing patterns have a refractive index of 1.3 to 2.5.

(17) A touch screen panel including the hybrid touch sensing electrode according to any one of the above (1) to (16).

(18) The touch screen panel according to the above (17), when one of the first optical functional layer and the second optical functional layer included in the hybrid touch sensing electrode is a retarder, and an optical functional film is adhered to an upper portion of the retarder by an adhesive agent, a refractive index difference between the sensing patterns formed on an upper side based on the retarder and an upper adhesive agent layer is 0.3 or less.

(19) The touch screen panel according to the above (17), when one of the first optical functional layer and the second optical functional layer included in the hybrid touch sensing electrode is a retarder, and an optical compensation film is adhered to an upper portion of the retarder by an adhesive agent, a refractive index difference between the sensing patterns formed on a lower side based on the retarder and an upper adhesive agent layer is 0.8 or less.

(20) The touch screen panel according to the above (17), the touch screen panel is adhered to a flexible display.

According to the hybrid touch sensing electrode of the present invention, since the dielectric constant/thickness value and the sum of dielectric constant have a specific range, respectively, it is possible to improve touch sensitivity and reduce noise.

According to the hybrid touch sensing electrode of the present invention, since the sensing patterns are directly formed on the optical functional layer included in the touch sensing electrode, an additional substrate forming the touch sensing electrode is not used, and thereby a thin film structure may be achieved.

In addition, according to the hybrid touch sensing electrode of the present invention, since the first sensing patterns and the second sensing patterns are respectively formed on different optical functional layers from each other, the optical functional layer may simultaneously perform as an insulation layer for the sensing patterns, and therefore, an additional insulation layer is not required, as well as a thin film structure may be achieved and the manufacturing process may be simplified.

Further, according to the hybrid touch sensing electrode of the present invention, since the refractive index difference between the optical functional layer and the sensing patterns has a specific range, it is possible to provide excellent visibility.

Further, according to the touch screen panel including the hybrid touch sensing electrode of the present invention, since the refractive index difference between the adhesive agent layer and the sensing pattern of the touch sensing electrode has a specific range, it is possible to provide excellent visibility.

Furthermore, since the hybrid touch sensing electrode of the present invention has a thin film structure as described above, it may be effectively applied to the flexible display, other than the general display.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic plan view of a conventional touch sensing electrode;

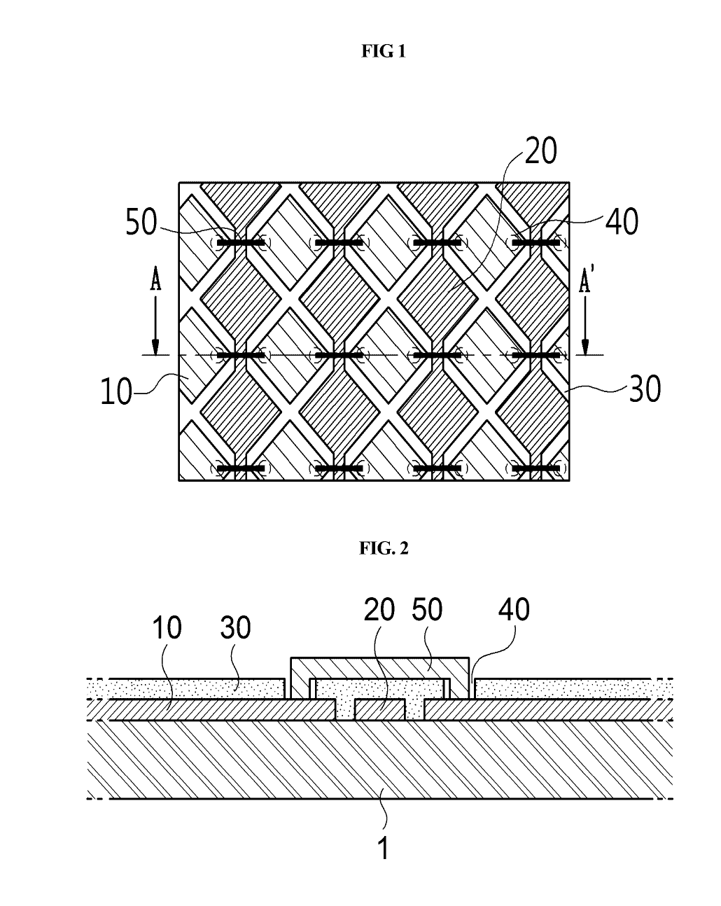

FIG. 2 is a schematic vertical sectional view of the conventional touch sensing electrode;

FIG. 3 is schematic exploded vertical sectional views illustrating embodiments of a hybrid touch sensing electrode of the present invention;

FIG. 4 is a schematic plan view of a hybrid touch sensing electrode according to one embodiment of the present invention; and

FIGS. 5 to 8 are schematic exploded vertical sectional views of hybrid touch sensing electrodes according to various embodiments of the present invention.

### DETAILED DESCRIPTION OF THE INVENTION

The present invention discloses a hybrid touch sensing electrode including first sensing patterns adhered to a first optical functional layer, and second sensing patterns adhered to a second optical functional layer, wherein the first and second optical functional layers have a dielectric constant/thickness value of 0.01 to 0.09 1/μm, respectively, and a sum of the dielectric constants of the first and second optical functional layers is 6 to 11, and thereby, the touch sensing electrode may be formed in a thin film structure with improved touch sensitivity while having reduced noise, as well as a touch screen panel including the same.

Hereinafter, exemplary embodiments of the present invention will be described in detail with reference to the accompanying drawings. However, those skilled in the related art will appreciate that such embodiments are provided for illustrative purposes and do not limit subject matters to be protected as disclosed in the detailed description and appended claims. Therefore, it will be apparent to those skilled in the related art that various alterations and modifications of the embodiments are possible within the scope and spirit of the present invention and duly included within the range as defined by the appended claims.

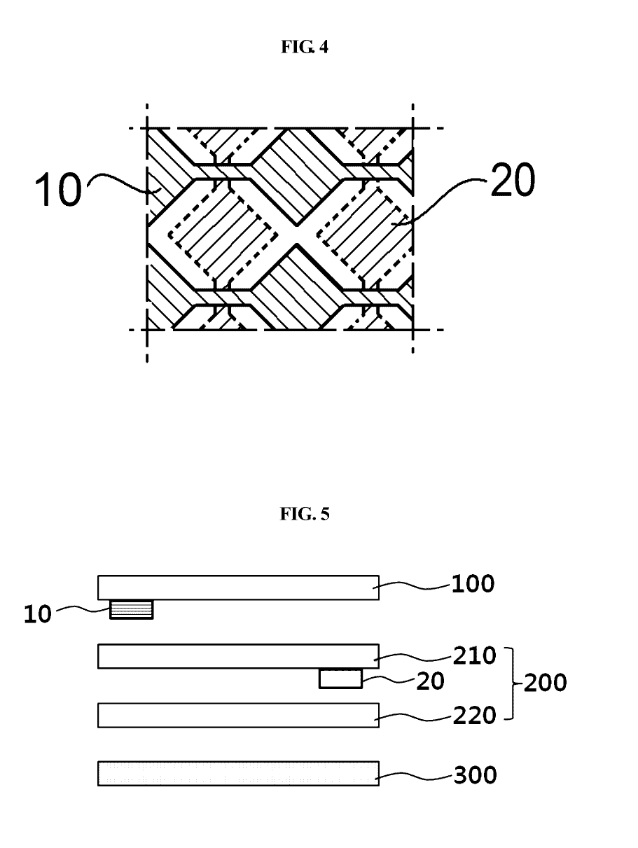

FIG. 3 is schematic exploded vertical sectional views illustrating embodiments of a hybrid touch sensing electrode of the present invention. The hybrid touch sensing electrode of the present invention illustrated in FIG. 3 includes first sensing patterns 10 and second sensing patterns 20 which are respectively formed on different optical functional layers from each other included in a touch screen panel.

In general, because the first sensing patterns 10 and the second sensing patterns 20 are formed on different optical functional layers from each other, there is a significant difference in the touch sensitivity depending on types of the optical functional layer. In this regard, the present inventor understands that a dielectric constant/thickness parameter of the optical functional layer is related to the touch sensitivity in the hybrid touch sensing electrode structure, has found a specific dielectric constant/thickness range representing excellent touch sensitivity and a dielectric constant range corresponding thereto, and has completed the present invention to provide suitable ranges thereof.

The first and second optical functional layers according to the present invention have a dielectric constant/thickness value of 0.01 to 0.09 1/μm, respectively, and a sum of the dielectric constants of the first and second optical functional layers is 6 to 11

When the dielectric constant/thickness value is less than 0.01 1/μm, a touch response speed may be significantly decreased or touch sensitivity may be lowered, while if the value exceeds 0.09 1/μm, noise may be increased. In addition, when the sum of the dielectric constants of the first and second optical functional layers is less than 6, the touch sensing electrode may not operate well, while if the sum thereof exceeds 11, noise may be increased.

The dielectric constant/thickness value may be controlled by varying the dielectric constant and the thickness values, wherein the dielectric constant value may be varied by changing a material of the optical functional layer, or adding a high dielectric constant material or a low dielectric constant material, or coating therewith.

The dielectric constant of the first optical functional layer according to the present invention is not particularly limited but may be, for example, 3.2 to 6.0, and the dielectric constant of the second optical functional layer may be 2.8 to 5.0. With regard to the dielectric constant in the present disclosure, when each optical functional layer has a multi-layered structure, the dielectric constant means an average dielectric constant of the entire multi-layered structure. Herein, touch sensitivity of the touch sensor may be improved by increasing a variation in mutual-capacitance (Cm) within the above-described range.

A thickness of the first and second optical functional layers according to the present invention is not particularly limited. For example, the first and second optical functional layers may have a thickness of 35 to 320 μm, and preferably 30 to 280 μm, respectively. When the first and second optical functional layers have a thickness within the above-described range, touch sensitivity of the touch sensor may be improved by increasing a variation in mutual-capacitance (Cm) within the above-described range.

Further, in the hybrid touch sensing electrode of the present invention, the dielectric constant/thickness value between the first and second sensing patterns is not particularly limited but may be, for example, 0.01 to 0.25 1/μm. When the dielectric constant/thickness value is within the above-described range, the touch sensitivity may be more improved.

A distance between the first sensing patterns (layer) formed on the first optical functional layer and the second sensing patterns (layer) formed on the second optical functional layer is not particularly limited but may be, for example, 12 to 300 μm. When the distance therebetween is within the above-described range, the touch sensor may be improved by increasing a variation in mutual-capacitance (Cm), and noise may be reduced.

In addition, a dielectric constant between the first sensing patterns and the second sensing patterns is not particularly limited but may be, for example, 2.8 to 5.0. When the dielectric constant therebetween is within the above-described range, the touch sensor may be improved by increasing a variation in mutual-capacitance (Cm), and noise may be reduced.

In the present invention, the optical functional layer on which the sensing patterns can be formed is not particularly limited so long as it may be included in the touch screen panel but may be, for example, a cover window 100, a polarization plate 200, and a retarder 300. Among these optical functional layers, first and second sensing patterns 10 and 20 are formed in different optical functional layers from each other.

Referring to FIG. 3, for example, the first sensing patterns 10 and the second sensing patterns 20 may be formed on one surface of the cover window 100 and one surface of the polarization plate 200 (see FIG. 3(a)), or one surface of the cover window 100 and one surface of the retarder 300 (see FIG. 3(b)), or one surface of the polarization plate 200 and one surface of the retarder 300 (see FIG. 3(c)), respectively.

As described above, if the first sensing patterns 10 and the second sensing patterns 20 forming the touch sensing electrode are formed on the different optical functional layers from each other, since electrical insulation between the first sensing patterns 10 and the second sensing patterns 20 is achieved by the optical functional layers, there is no need to include an additional insulation layer, and thereby a thin film structure may be implemented.

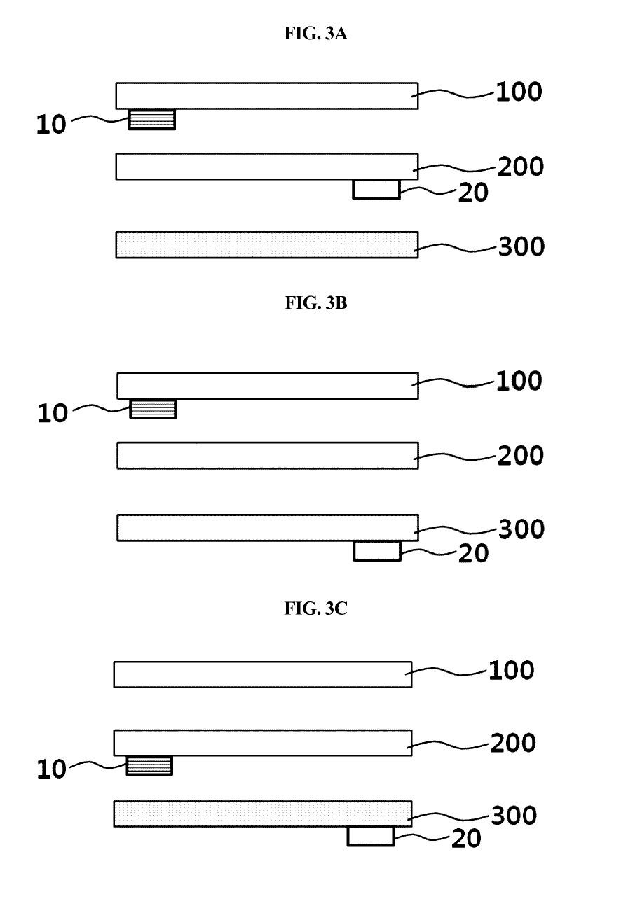

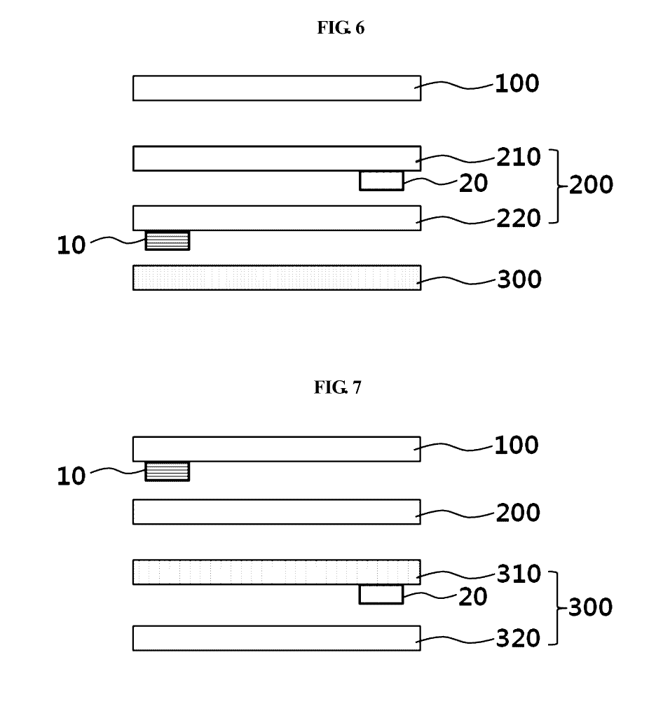

FIG. 4 is a schematic plan view of the hybrid touch sensing electrode according to the present invention. Referring to FIG. 4, the bridge electrodes (i.e. connection electrodes) 50 are required in the conventional structure (FIG. 2) in which the first sensing patterns 10 and the second sensing patterns 20 are formed on the same plane, however, since different sensing patterns from each other are disposed on the different optical functional layers from each other, that is, disposed on different planes from each other, the respective patterns may have a structure electrically connected with each other without using the bridge electrodes 50. Therefore, the thin film structure may be implemented and the manufacturing process of the touch sensing electrode may be significantly simplified, and manufacturing time and costs may be reduced.

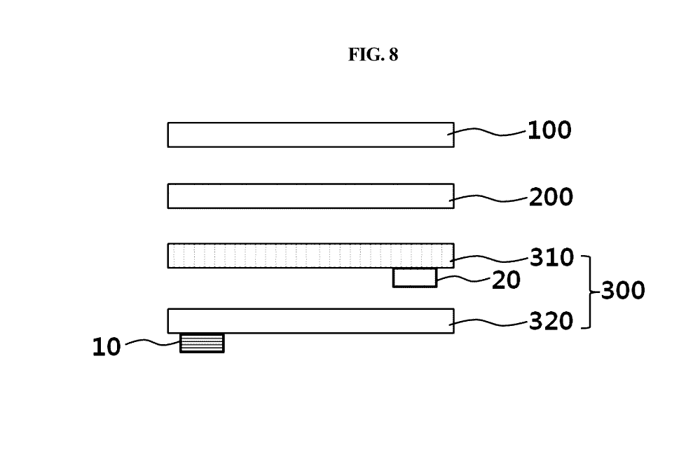

In one embodiment of the present invention, when at least one of the first and second sensing patterns 10 and 20 is formed on the cover window 100, the cover window 100 may use any material generally used in the related art without particular limitation thereof within a range without departing from the purpose of the present invention, and specifically, a window film of polyimide, or poly(methyl methacrylate) (PMMA) polymer, etc may be used. Further, in one embodiment of the present invention, when at least one of the first and second sensing patterns 10 and 20 is formed on the polarization plate 200, only one of the first sensing patterns 10 and the second sensing patterns 20 may be formed on the polarization plate 200 or both of them may be formed on the polarization plate 200 depending on the structure of the polarization plate. Specifically, the retarder 300 may be a single polarizer layer, as illustrated in FIG. 3, or a laminate in which a protective film 220 is adhered to at least one surface of a polarizer 210, as illustrated in FIGS. 5 and 6.

When the polarization plate 200 is the polarizer 210 or the laminate in which the protective film 220 is adhered to at least one surface of the polarizer 210, the polarizer 210 and the protective film 220 may be an individual optical functional layer, respectively. Accordingly, in the present invention, the first sensing patterns 10 and the second sensing patterns 20 may be respectively formed on the polarizer 210 and the protective film 220.

FIG. 5 illustrates a structure in which the first sensing patterns 10 and the second sensing patterns 20 are respectively formed on the cover window 100 and the polarizer 210 of the polarization plate 200, and FIG. 6 illustrates a structure in which the first sensing patterns 10 and the second sensing patterns 20 are respectively formed on the polarizer 210 and the protective film 220 of the polarization plate 200.

In FIGS. 5 and 6, the laminating order of the polarizer 210 and the protective film 220 is no more than an example, and therefore it is not particularly limited thereto, and the laminating order may be changed with each other. When, the protective films 220 are adhered to both surfaces of the polarizer 210, all the protective films 220 are different optical functional layers from each other on both surfaces, and therefore first sensing patterns 10 and the second sensing patterns 20 may be formed on different protective films 220 from each other. In addition, surfaces on which first sensing patterns 10 and the second sensing patterns 20 are formed are not particularly limited so long as they are not the same plane.

Any polarizers used in the related art may be adopted to the polarizer film without particular limitation thereof. For example, a film made of a polyvinylalcohol resin having a dichroic dye adsorbed and oriented thereon may be used as the polarizer. Such a polyvinylalcohol resin forming the polarizer may include polyvinyl acetate as a homopolymer of vinyl acetate, as well as a copolymer of vinyl acetate and any other monomer copolymerizable therewith. Such a monomer copolymerizable with vinyl acetate may include, for example, unsaturated carboxylic acid monomers, unsaturated sulfonic acid monomers, olefin monomers, vinyl ether monomers, ammonium group-containing acrylamide monomers, or the like. A thickness of the polarizer is not particularly limited, and the polarizer may be manufactured so as to have any conventional thickness used in the related art.

In addition, the polarizer may be formed by directly applying a polymer solution containing a polymer resin and a dichroic material on the different optical functional layers or the protective film. Preferably, a polarizer coating layer is used when the polarizing plate is formed in a single polarizer layer.

The polymer resin for forming the polarizer coating layer may representatively use, for example, a polyvinylalcohol resin. The polyvinylalcohol resin may be a polyvinylalcohol resin prepared by saponification of a polyvinyl acetate resin. Such a polyvinyl acetate resin may include polyvinyl acetate as a homopolymer of vinyl acetate, as well as a copolymer of vinyl acetate and any other monomer copolymerizable therewith. Such a monomer copolymerizable with vinyl acetate may include, for example, unsaturated carboxylic acid monomers, unsaturated sulfonic acid monomers, olefin monomers, vinyl ether monomers, ammonium group-containing acrylamide monomers, and the like.

Also, the polyvinyl alcohol resin may include modified resin, for example, aldehyde-modified polyvinylformal or polyvinylacetal.

The polarizer layer may be formed by a film prepared by mixing a polyvinyl alcohol resin with a dichroic material and applying the mixed solution in a film.

Films having excellent properties such as transparency, mechanical strength, thermal stability, moisture-shielding properties, isotropic properties, or the like, may be used as the protective film. More particularly, there is a film prepared of a thermoplastic resin including, for example: a polyester resin such as polyethylene terephthalate, polyethylene isophthalate, polyethylene naphthalate, polybutylene terephthalate, etc.; a cellulose resin such as diacetyl cellulose, triacetyl cellulose, etc.; a polycarbonate resin; an acryl resin such as polymethyl (meth)acrylate, polyethyl (meth)acrylate, etc.; a styrene resin such as polystyrene, acrylonitrile-styrene copolymer, etc.; a polyolefin resin such as polyethylene, polypropylene, a polyolefin having a cyclo- or norbonene structure, ethylene-propylene copolymer, etc.; a vinyl chloride resin; an amide resin such as nylon, an aromatic polyamide, etc.; an imide resin; a polyethersulfone resin; a sulfone resin; a polyetheretherketone resin; a polysulfide phenylene resin; a vinyl alcohol resin; a vinylidene chloride resin; a vinylbutyral resin, an allylate resin; a polyoxymethylene resin; an epoxy resin, and the like. Additionally, a film including a blend of the above thermoplastic resins may also be used. Alternatively, a film prepared of a thermosetting resin such as (meth)acryl, urethane, acrylurethane, epoxy or silicon resins, etc. or UV-curable resins may be used.

The thermoplastic resin of the polarizer protective film may be included in an amount of 50 to 100 wt. %, preferably, 50 to 99 wt. %, more preferably, 60 to 98 wt. %, and most preferably, 70 to 97 wt. % to a total weight of the polarizer protective film. If a content of the thermoplastic resin is less than 50 wt. %, a high transparency inherently included in the thermoplastic resin may not be sufficiently expressed.

The protective film described above may include at least one suitable additive. The additive may include, for example, UV-absorbers, antioxidants, lubricants, plasticizers, releasing agents, anti-coloring agents, flame retardants, nucleating agents, antistatic agents, pigments, colorants, and the like.

Optionally, the polarizer protective film may be surface treated. Such a surface treatment may include a drying process such as plasma processing, corona treatment, primer processing, etc., or chemical treatment such as alkalization including saponification.

In another embodiment of the present invention, at least one of the first and second sensing patterns 10 and 20 may be formed on the retarder 300. The retarder 300 functions to change a phase of transmitting light. For example, the retarder may be an optical compensation layer for expanding a viewing angle or a quarter wave film layer (λ/4 plate) for anti-reflection. When the hybrid touch sensing electrode of the present invention is used in a flexible display, it is preferable that the retarder is the quarter wave film layer.

When at least one of the first and second sensing patterns 10 and 20 is formed on the retarder 300, similar to the case of polarization plate 200, only one of the first sensing patterns 10 and the second sensing patterns 20 may be formed on the retarder 300 or both of them may be formed on the retarder 300 depending on the structure of the retarder.

Specifically, the retarder 300 may be a single layer, as illustrated in FIG. 3, or a laminate in which a hardened liquid crystal film 310 is adhered to one surface of a substrate 320 as illustrated in FIGS. 7 and 8. Herein, the substrate 320 may be a conventional protective film, an alignment film for inducing an orientation of liquid crystalline compounds, and a laminate of the protective film and the alignment film.

When the retarder 300 is the laminate in which the hardened liquid crystal film 310 is adhered to one surface of the substrate 320, the hardened liquid crystal film 310 and the substrate 320 may be an individual optical functional layer, respectively. Accordingly, in the present invention, the first sensing patterns 10 and the second sensing patterns 20 may be respectively formed on the hardened liquid crystal film 310 and the substrate 320.

FIG. 7 illustrates a structure in which the first sensing patterns 10 and the second sensing patterns 20 are respectively formed on the cover window 100 and the hardened liquid crystal film 310 of the retarder 300, and FIG. 8 illustrates a structure in which the first sensing patterns 10 and the second sensing patterns 20 are respectively formed on the hardened liquid crystal film 310 and the substrate 320 of the retarder 300.

In FIGS. 7 and 8, the laminating order of the hardened liquid crystal film 310 and the substrate 320 is no more than an example, and therefore it is not particularly limited thereto, and the laminating order may be changed with each other. In addition, as necessary, the substrate 320 may be formed by a laminate film of the alignment film and the protective film. In this case, since the alignment film and the protective film are the different optical functional layers from each other, respectively, the first sensing patterns 10 and the second sensing patterns 20 may be respectively formed on the alignment film and the protective film. In addition, surfaces on which first sensing patterns 10 and the second sensing patterns 20 are formed are also not particularly limited so long as they are not the same plane.

Any film or coating layer used in the related art may be adopted to the single retarder layer without particular limitation thereof. For example, the retarder may be a stretched polymer film or a coating layer prepared by directly applying a polymer solution containing a reactive liquid crystal monomer on a predetermined substrate or the different optical functional layers.

A type of the polymer used in the polymer film is not particularly limited, and any material generally used in the related art may be used without particular limitation thereof within a range coinciding with the purpose of the present invention, and specifically, a polycarbonate film, a polycarbonate hybrid film, a cyclic olefin polymer (COP) film, and the like may be used.

The laminate retarder may be prepared by applying a polymer solution containing liquid crystalline compounds on the substrate and curing the same. Herein, the substrate may be a conventional transparent protective film, and an alignment film for inducing an orientation of the liquid crystalline compounds.

The above-described protective film may be used as the protective film within the same category, and any film used in the related art may be used as the alignment film without particular limitation thereof, and an organic alignment film is preferably used.

The organic alignment film may be formed by using an alignment film composition containing acrylate, polyimide, or polyamic acid. The polyamic acid may be a polymer prepared by reacting diamine with dianhydride, and the polyimide may be prepared by thermally imidizing the polyamic acid, and structures thereof are not particularly limited.

The prepared alignment film has an appropriate alignment property applied in a subsequent process. A method of applying the alignment property is not particularly limited. For example, rubbing, photo-curing process by exposing, or the like may be used.

The hardened liquid crystal film formed on the substrate may be formed by applying a hardened liquid crystal film composition on the substrate. The hardened liquid crystal film composition used in the present invention may include a liquid crystal compound having optical isotropic properties and cross-linking properties controlled by the application of light. For example, a reactive liquid crystal monomer (RM) is preferably used.

In addition, when the first sensing patterns 10 and the second sensing patterns 20 are respectively formed on the polarization plate 200 and the retarder 300 (see FIG. 3(c)), as described above, if each of the polarization plate 200 and the retarder 300 is a laminate, the first sensing patterns 10 and the second sensing patterns 20 may be respectively formed on an individual optical functional layer forming each respective laminate.

Any conventional materials used in the related art may be adopted to the first and second sensing patterns 10 and 20 without particular limitation thereof. In order to prevent the visibility of an image displayed on a screen from being deteriorated, transparent material may be used, or preferably formed in micropatterns. Specifically, a conductive material used for forming the sensing patterns may include, for example, indium-tin oxide (ITO), indium-zinc oxide (IZO), zinc oxide (ZnO), indium-zinc-tin oxide (IZTO), cadmium-tin oxide (CTO), poly(3,4-ethylenedioxythiopene) (PEDOT), carbon nanotube (CNT), metal wire, etc. These may be used alone or in a combination of two or more thereof.

Metals used in the metal wire are not particularly limited but may include, for example, silver, gold, aluminum, copper, iron, nickel, titanium, tellurium, chromium, etc., which are used alone or in a combination of two or more thereof.

In order to form the first and second sensing patterns 10 and 20 on the optical functional layer, the optical functional layer may use a material having excellent heat resistance, or may be prepared by applying printing, coating, a low temperature (room temperature) sputtering method, or the like.

Refractive Index

The hybrid touch sensing electrode of the present invention may have more improved visibility by controlling a refractive index difference between the optical functional layer and the sensing patterns.

For example, both of refractive index differences between the first optical compensation layer and the first sensing patterns, and between the second optical compensation layer and the second sensing patterns may be 0.8 or less. If the refractive index difference therebetween is increased due to the sensing patterns having a high refractive index, the sensing patterns may be visually identified from an outside, and thereby visibility may be deteriorated. In consideration of this, according to the present invention, since the refractive index difference between the optical functional layer and the sensing patterns provided on the optical functional layer is controlled to be 0.8 or less, the difference in refractive indices between the sensing patterns and the optical functional layer is minimized, and thereby visibility may be more improved. A specific value of the refractive index may be controlled by any method known in the related art depending on a thickness of each layer, a specific type of the material, or the like. In this aspect, preferably, the sensing patterns have a refractive index of 1.3 to 2.5. If the sensing patterns have a refractive index within the above-described range, the difference in refractive indices between the sensing patterns and the optical functional layer may be easily included within the range of the present invention, and effects of improving visibility may be more increased.

The hybrid touch sensing electrode of the present invention having the above-described configuration may further include a structure in which an adhesive layer and a release film are sequentially laminated on at least one surface thereof so as to facilitate managing in subsequent transportation and adhesion with other parts.

The hybrid touch sensing electrode of the present invention may be used to form a touch screen panel by an additional process known in the related art.

For example, the hybrid touch sensing electrode of the present invention may have optical functional films adhered to an upper portion and a lower portion thereof by an adhesive agent. In the present invention, the adhesive agent means an adhesive or a bonding agent.

Further, in the present invention, the upper portion of any optical functional layer refers to a visible side based on the optical functional layer and the lower portion of any optical functional layer refers to a side opposite to the visible side based on the optical functional layer.

In the touch screen panel of the present invention, an improvement in visibility of the sensing patterns is determined based on the retarder.

Preferably, as one embodiment of the present invention, when the hybrid touch sensing electrode includes a retarder, and an optical functional film is adhered to an upper portion of the retarder by an adhesive agent, a refractive index difference between the sensing patterns formed on an upper side based on the retarder and an upper adhesive agent layer is 0.3 or less in aspects of improving visibility of the sensing patterns. When any one optical functional layer is the retarder, since light emitted from a light source is incident to the adhesive agent layer and the sensing patterns before passing through the optical functional layer of the retarder, it is not possible to decrease the refractive index of the sensing patterns unless the difference in refractive indices between the adhesive agent layer and the sensing patterns is 0.3 or less.

In the present invention, the sensing patterns formed on the upper side of the retarder refer to a case in which the sensing patterns are formed on the upper surface of the retarder, and other optical functional layer(s) is (are) disposed on the upper portion of the retarder and the sensing patterns are formed on the optical functional layer(s). Accordingly, any one of the first sensing pattern and the second sensing pattern may be the retarder.

Preferably, as another embodiment of the present invention, when an optical functional film is adhered to the upper portion of the retarder by an adhesive agent, a refractive index difference between the sensing patterns formed on a lower side based on the retarder and the upper adhesive agent layer is 0.8 or less. When any one optical functional layer is the retarder, if the refractive index difference between the sensing pattern of the lower side to which the incident light is met after passing through the optical functional layer of the retarder and the upper adhesive agent layer exceeds 0.8, visibility of the sensing patterns of the lower side may be deteriorated.

In the present invention, the sensing patterns formed on the lower side of the retarder refer to a case in which the sensing patterns are formed on the lower surface of the retarder, and other optical functional layer(s) is (are) disposed on the lower portion of the retarder and the sensing patterns are formed on the optical functional layer(s). Accordingly, any one of the first sensing pattern and the second sensing pattern may be the retarder.

The optical functional film which may be adhered to the hybrid touch sensing electrode of the present invention may, for example, include a window cover film, a polarization plate, a retarder, an anti-reflection film, an antifouling film, or the like, but it is not limited thereto.

The touch screen panel according to the present invention may be coupled to a display device such as a liquid crystal display (LCD), an OLED, a flexible display, or the like.

### EXAMPLE

### Example 1

First, ITO was deposited on a window film at room temperature and heat treated to prepare an ITO layer. Next, a touch pattern was formed with the ITO layer by using a photolithography process. Then, a wiring electrode was formed by depositing and etching a metal material to manufacture a first touch sensing electrode.

On the other hand, ITO was deposited on a retarder at room temperature and heat treated to prepare an ITO layer, and then, a touch pattern was formed with the ITO layer by using a photolithography process. Next, a wiring electrode was formed by depositing and etching a metal material to manufacture a second touch sensing electrode.

Thereafter, a polarization plate is inserted and adhered between the window film having the first touch sensing electrode formed thereon and the retarder having the second touch sensing electrode formed thereon to prepare a touch module having a total thickness of 300 μm.

### Example 2

First, ITO was deposited on a window film at room temperature and heat treated to prepare an ITO layer. Next, a touch pattern was formed with the ITO layer by using a photolithography process. Then, a wiring electrode was formed by depositing and etching a metal material to manufacture a first touch sensing electrode.

On the other hand, ITO was deposited on a polarization plate at room temperature and heat treated to prepare an ITO layer, and then, a touch pattern was formed with the ITO layer by using a photolithography process. Next, a wiring electrode was formed by depositing and etching a metal material to manufacture a second touch sensing electrode.

Thereafter, the window film having the first touch sensing electrode formed thereon and the polarization plate having the second touch sensing electrode formed thereon are adhered to each other, and a retarder is adhered to a surface of the polarization plate opposite to the surface to which the second touch sensing electrode is adhered to prepare a touch module having a total thickness of 273 μm.

### Example 3

First, ITO was deposited on a polarization plate at room temperature and heat treated to prepare an ITO layer. Next, a touch pattern was formed with the ITO layer by using a photolithography process. Then, a wiring electrode was formed by depositing and etching a metal material to manufacture a first touch sensing electrode.

On the other hand, ITO was deposited on a retarder at room temperature and heat treated to prepare an ITO layer, and then, a touch pattern was formed with the ITO layer by using a photolithography process. Next, a wiring electrode was formed by depositing and etching a metal material to manufacture a second touch sensing electrode.

Thereafter, the polarization plate having the first touch sensing electrode formed thereon and the retarder having the second touch sensing electrode formed thereon are adhered to each other so that the first touch sensing electrode is positioned between the polarization plate and the retarder, and a window film is adhered to a surface of the polarization plate opposite to the surface to which the first touch sensing electrode is adhered to prepare a touch module having a total thickness of 280 μm.

### Example 4

First, ITO was deposited on a polarization plate at room temperature and heat treated to prepare an ITO layer. Next, a touch pattern was formed with the ITO layer by using a photolithography process. Then, a wiring electrode was formed by depositing and etching a metal material to manufacture a first touch sensing electrode.

On the other hand, ITO was deposited on a retarder at room temperature and heat treated to prepare an ITO layer, and then, a touch pattern was formed with the ITO layer by using a photolithography process. Next, a wiring electrode was formed by depositing and etching a metal material to manufacture a second touch sensing electrode.

Thereafter, the polarization plate having the first touch sensing electrode formed thereon and the retarder having the second touch sensing electrode formed thereon are adhered to each other so that the polarization plate and the retarder are positioned between the first touch sensing electrode and the second touch sensing electrode, and a window film is adhered to a surface of the polarization plate opposite to the surface to which the first touch sensing electrode is adhered to prepare a touch module having a total thickness of 280 μm.

### Comparative Example 1

ITO was deposited on a window sheet at room temperature and heat treated to prepare an ITO layer, and then, a touch pattern was formed with the ITO layer by using a photolithography process. Next, a wiring electrode was formed by depositing and etching a metal material to manufacture a first touch sensing electrode.

In addition, ITO was deposited on any one surface of a retarder at room temperature and heat treated to prepare an ITO layer, and then, a touch pattern was formed with the ITO layer by using a photolithography process. Next, a wiring electrode was formed by depositing and etching a metal material to manufacture a second touch sensing electrode.

Thereafter, the retarder having the second touch sensing electrode formed thereon and a polarization plate are adhered to each other, and the window sheet having the first touch sensing electrode formed thereon is adhered to an upper surface of the polarization plate to prepare a touch module having a total thickness of 914 μm.

### Comparative Example 2

ITO was deposited on a window sheet at room temperature and heat treated to prepare an ITO layer, and then, a touch pattern was formed with the ITO layer by using a photolithography process. Next, a wiring electrode was formed by depositing and etching a metal material to manufacture a first touch sensing electrode.

In addition, ITO was deposited on any one surface of a polarization plate at room temperature and heat treated to prepare an ITO layer, and then, a touch pattern was formed with the ITO layer by using a photolithography process. Next, a wiring electrode was formed by depositing and etching a metal material to manufacture a second touch sensing electrode.

Thereafter, the window sheet having the first touch sensing electrode formed thereon and the polarization plate having the second touch sensing electrode formed thereon are adhered to each other, and a retarder is adhered to a lower surface of the polarization plate to prepare a touch module having a total thickness of 2,983 μm.

### Comparative Example 3

A touch module having a total thickness of 520 μm was prepared according to the same procedure as described in Example 3, except that p-3 and r-2 were used as a polarization plate and a retarder, respectively.

### Comparative Example 4

A touch module having a total thickness of 430 μm was prepared according to the same procedure as described in Example 1, except that w-3 and r-3 were used as a window film and a retarder, respectively.

### Comparative Example 5

A touch module having a total thickness of 320 μm was prepared according to the same procedure as described in Example 1, except that w-2 and r-4 were used as a window film and a retarder, respectively.

### Comparative Example 6

A touch module having a total thickness of 320 μm was prepared according to the same procedure as described in Example 3, except that p-4 and r-3′ were used as a polarization plate and a retarder, respectively.

### Comparative Example 7

A touch module having a total thickness of 300 μm was prepared according to the same procedure as described in Example 3, except that p-4 and r-3″ were used as a polarization plate and a retarder, respectively.

Dielectric constants of each layer of the touch modules prepared in Examples and Comparative Examples were measured, and results thereof are shown in Table 1 below. Herein, when each optical functional layer has a multi-layered structure, an average dielectric constant was used.

### Experimental Example 1

### Measurement of Touch Sensitivity (Evaluation of Touch Sensitivity by Measuring Variations in Cm)

In order to evaluate touch sensitivity of touch screen panels prepared according to the above-described manufacturing method in sequential orders stated in Table 1 below, variations in mutual-capacitance (Cm) were measured and the measured variations were compared to a value of Comparative Example 2 which is assumed to be 100 and used as a standard of comparison, then touch sensitivities (variation in Cm) are shown in Table 1 as a relative ratio (%) thereto.

### Experimental Example 2

### Measurement of Noise (Variations in Voltage of a Driving IC)

In order to evaluate noise of touch screen panels prepared according to the above-described manufacturing method in sequential orders stated in Table 1 below, after preparing the touch modules, variations in voltage of a driving IC were measured and the measured variations were compared to a value of Comparative Example 2 which is assumed to be 100 and used as a standard of comparison, then noise (variations in voltage of a driving IC) are shown in Table 1 as a relative ratio (%) thereto.

TABLE 1

| | | | | | | | | | | Noise |
|---|---|---|---|---|---|---|---|---|---|---|
| | | | Second | | | Between first and | | | | (variation |
| | First optical | | optical | | | second optical | | | Touch | in |
| | functional | | functional | | | functional layers | | | sensitivity | voltage |
| | layer | | layer | | | | | Dieletric | (variation | of |
| | | ε1/ | | ε2/ | | | | constant/ | in | driving |
| | | thickness | | Thickness | ε1 + | Dieletric | Distance | distance | Cm) | IC) |
| Section | Type | [1/μm] | Type | [1/μm] | ε2 | constant | [μm] | [1/μm] | [%] | [%] |
| Example | w-1 | 0.035 | r-1 | 0.068 | 6.7 | 3 | 119 | 0.025 | 115% | 80% |
| 1 | | | | | | | | | | |
| Example | w-2 | 0.07 | p-1 | 0.05 | 7.4 | 3 | 60 | 0.05 | 134% | 85% |
| 2 | | | | | | | | | | |
| Example | p-2 | 0.02 | r-1 | 0.068 | 7 | 3.5 | 51 | 0.069 | 137% | 95% |
| 3 | | | | | | | | | | |
| Example | p-2 | 0.02 | r-1 | 0.068 | 7 | 3 | 333 | 0.009 | 105% | 88% |
| 4 | | | | | | | | | | |
| Comparative | w-s1 | 0.004 | r-1 | 0.068 | 6.6 | 3 | 119 | 0.025 | 83% | 82% |
| Example | | | | | | | | | | |
| 1 | | | | | | | | | | |
| Comparative | w-s2 | 0.001 | p-3 | 0.009 | 5.8 | 3 | 333 | 0.009 | 100% | 100% |
| Example | | | | | | | | | | |
| 2 | | | | | | | | | | |
| Comparative | p-3 | 0.009 | r-2 | 0.009 | 7 | 3.5 | 51 | 0.069 | 98% | 97% |
| Example | | | | | | | | | | |
| 3 | | | | | | | | | | |
| Comparative | w-3 | 0.95 | r-3 | 0.15 | 6.7 | 3 | 105 | 0.029 | 90% | 115% |
| Example | | | | | | | | | | |
| 4 | | | | | | | | | | |
| Comparative | w-2 | 0.07 | r-4 | 0.98 | 7.4 | 6 | 145 | 0.04 | 118% | 120% |
| Example | | | | | | | | | | |
| 5 | | | | | | | | | | |
| Comparative | p-4 | 0.02 | r-3′ | 0.068 | 4 | 3.5 | 51 | 0.069 | 90% | 95% |
| Example | | | | | | | | | | |
| 6 | | | | | | | | | | |
| Comparative | p-4 | 0.02 | r-3″ | 0.068 | 13 | 3.5 | 25 | 0.069 | 137% | 160% |
| Example | | | | | | | | | | |
| 7 | | | | | | | | | | |

w-1: polyimide window film
w-2: poly(methyl methacrylate) (PMMA) window film
w-3: polyimide hybrid window film
w-s1: polycarbonate (PC) window sheet
w-s2: polyethylene naphthalate (PEN) window sheet
p-1: cyclic olefin polymer (COP)/Polyvinyl Alcohol (PVA)/cyclic olefin polymer (COP) film type polarizing plate
p-2: coating layer type polarizing plate
p-3: polarization plate of triacetyl cellulose (TAC)/polyvinyl alcohol (PVA)/triacetyl cellulose (TAC)
p-4: coating layer type hybrid polarization plate
r-1: polycarbonate film retarder
r-2: cyclic olefin polymer (COP) film retarder
r-3: polycarbonate (PC) hybrid film retarder I
r-3′: polycarbonate (PC) hybrid film retarder II
r-3″: polycarbonate (PC) hybrid film retarder III
r-4: coating layer type retarder

Referring to Table 1, it can be seen that Examples included within the range of the present invention generally have a larger mutual-capacitance than Comparative Examples, and thereby exhibiting excellent touch sensitivity and reduced noise evaluated by variations in voltage of a driving IC.

For reference, the r-3, r-3′ and r-3″ retarders are prepared by controlling a type of a dielectric material mixed with polycarbonate (PC) and the thickness of the retarder, respectively.

### Examples 5 to 14

Touch screen panels including hybrid touch sensing electrodes were prepared according to sequential orders and refractive index stated in Table 3 below, and then, average reflectance of a pattern part and a non-pattern part for each position was measured. Herein, the pattern part is a part on which the sensing pattern is formed and the non-pattern part is a part on which the sensing pattern is not formed (that is, a part to which the optical functional layer is exposed).

The average reflectance means an average of reflectance within a range of 400 nm to 700 nm.

Dielectric constant (∈)/thickness of each optical functional layer and a sum of the dielectric constants in relation to Examples 5 to 14 are shown in Table 2 below.

TABLE 2

| ε/thickness [1/μm] of | | ε/thickness [1/μm] of | | Sum of dielectric |
|---|---|---|---|---|
| optical functional layer | | optical functional layer | | constants |
| r-1 | 0.068 | p-1 | 0.05 | 7.1 |
| r-1 | 0.068 | p-2 | 0.02 | 7.0 |
| r-2 | 0.070 | p-1 | 0.05 | 7.0 |
| r-2 | 0.070 | p-2 | 0.02 | 6.9 |

TABLE 3

| | | | | | | | | | | Δ | |
|---|---|---|---|---|---|---|---|---|---|---|---|
| | | | | | Second | | | | | Reflectance | |
| | First | | | | optical | | | | | (%) | |
| | optical | | | | functional | | | | | (electrode/ | |
| | functional | | | | layer | | Second | | Adhesive | adhesive | |
| | layer | | First sensing | | [polarization | | sensing | | agent | agent) | |
| | [retarder] | | pattern | | plate] | | pattern | | layer | First | Second |
| Section | Type | Reflectance | Position | Reflectance | Type | Reflectance | Position | Reflectance | Reflectance | electrode | electrode |
| Example | r-1 | 1.53 | Retarder | 1.56 | p-1 | 1.53 | Polarizing | 1.56 | 1.54 | 0.004 | 0.004 |
| 5 | | | upper | | | | plate | | | | |
| | | | surface | | | | upper | | | | |
| | | | | | | | surface | | | | |
| Example | r-2 | 1.58 | Retarder | 1.61 | p-1 | 1.53 | Polarizing | 1.61 | 1.56 | 0.025 | 0.025 |
| 6 | | | upper | | | | plate | | | | |
| | | | surface | | | | upper | | | | |
| | | | | | | | surface | | | | |
| Example | r-1 | 1.53 | Retarder | 1.61 | p-2 | 1.55 | Polarizing | 1.53 | 1.58 | 0.088 | 0.026 |
| 7 | | | upper | | | | plate | | | | |
| | | | surface | | | | lower | | | | |
| | | | | | | | surface | | | | |
| Example | r-1 | 1.53 | Retarder | 1.56 | p-1 | 1.53 | Polarizing | 1.55 | 1.58 | 0.041 | 0.092 |
| 8 | | | lower | | | | plate | | | | |
| | | | surface | | | | upper | | | | |
| | | | | | | | surface | | | | |
| Example | r-2 | 1.58 | Retarder | 1.62 | p-1 | 1.53 | Retarder | 1.60 | 1.58 | 0.015 | 0.004 |
| 9 | | | lower | | | | upper | | | | |
| | | | surface | | | | surface | | | | |
| Example | r-2 | 1.58 | Retarder | 1.64 | p-2 | 1.55 | Polarizing | 1.61 | 1.62 | 0.004 | 0.001 |
| 10 | | | lower | | | | plate | | | | |
| | | | surface | | | | lower | | | | |
| | | | | | | | surface | | | | |
| Example | r-1 | 1.53 | Retarder | 2.4 | p-1 | 1.53 | Retarder | 2.4 | 1.52 | 5.0 | 5.0 |
| 11 | | | upper | | | | upper | | | | |
| | | | surface | | | | surface | | | | |
| Example | r-2 | 1.58 | Retarder | 1.68 | p-1 | 1.53 | Retarder | 2.2 | 1.54 | 0.19 | 3.1 |
| 12 | | | upper | | | | lower | | | | |
| | | | surface | | | | surface | | | | |
| Example | r-1 | 1.53 | Retarder | 2.4 | p-2 | 1.55 | Retarder | 1.96 | 1.55 | 4.6 | 1.3 |
| 13 | | | lower | | | | upper | | | | |
| | | | surface | | | | surface | | | | |
| Example | r-1 | 1.53 | Retarder | 1.66 | p-1 | 1.53 | Retarder | 2.1 | 1.62 | 0.014 | 1.7 |
| 14 | | | lower | | | | lower | | | | |
| | | | surface | | | | surface | | | | |

r-1: r-1 retarder of Table 1
r-2: coating layer type retarder
p-1: p-1 polarization plate of Table 1
p-2: p-2 polarization plate of Table 1
First sensing pattern: ITO
Second sensing pattern: ITO
The reflectance and extinction coefficient are based on a light having a wavelength of 550 nm

Referring to Table 3, it can be seen that when the refractive index difference between the optical functional layer and the sensing patterns formed on the optical functional layer is 0.8 or less, the visibility may be more superior.

In addition, when the optical functional layer is a retarder, and the refractive index difference between the sensing patterns formed on the upper side of the retarder and the upper adhesive agent layer is 0.3 or less, the visibility may be more improved. Further, when the refractive index difference between the sensing patterns formed on a lower side of the retarder and the upper adhesive agent layer is 0.8 or less, the visibility may also be more superior.

### DESCRIPTION OF REFERENCE NUMERALS

1: substrate
10: first sensing pattern, 20: second sensing pattern
100: cover window
200: polarization plate or single polarizer
210: polarizer, 220: protective film
300: retarder
310: hardened liquid crystal film, 320: substrate

1. A hybrid touch sensing electrode comprising:
first sensing patterns adhered to a first optical functional layer, and second sensing patterns adhered to a second optical functional layer,
wherein the first and second optical functional layers have a dielectric constant/thickness value of 0.01 to 0.09 1/μm, respectively, and a sum of the dielectric constants of the first and second optical functional layers is 6 to 11.

2. The hybrid touch sensing electrode according to claim 1, wherein the first optical functional layer has a dielectric constant of 3.2 to 6.0, and the second optical functional layer has a dielectric constant of 2.8 to 5.0.

3. The hybrid touch sensing electrode according to claim 1, wherein the first optical functional layer has a thickness of 35 to 320 μm, and the second optical functional layer has a thickness of 30 to 280 μm.

4. The hybrid touch sensing electrode according to claim 1, wherein the first optical functional layer and the second optical functional layer are independently included in the touch screen panel.

5. The hybrid touch sensing electrode according to claim 1, wherein a dielectric constant/distance value between the first sensing patterns and the second sensing patterns is 0.01 to 0.25 1/μm.

6. The hybrid touch sensing electrode according to claim 1, wherein a distance between the first sensing patterns and the second sensing patterns is 12 to 300 μm.

7. The hybrid touch sensing electrode according to claim 1, wherein a dielectric constant between the first sensing patterns and the second sensing patterns is 2.8 to 5.0.

8. The hybrid touch sensing electrode according to claim 1, wherein the first optical functional layer and the second optical functional layer are selected from a group consisting of a cover window, a polarization plate and a retarder, but are not the same as each other.

9. The hybrid touch sensing electrode according to claim 8, wherein the polarization plate is a single polarizer layer or a laminate in which a protective film is adhered to at least one surface of the polarizer.

10. The hybrid touch sensing electrode according to claim 9, wherein the polarizer and the protective film included in the laminate polarization plate are an individual optical functional layer, respectively.

11. The hybrid touch sensing electrode according to claim 8, wherein the retarder is a single layer or a laminate in which a hardened liquid crystal film is adhered to one surface of a substrate.

12. The hybrid touch sensing electrode according to claim 11, wherein the substrate and the hardened liquid crystal film included in the laminate retarder are an individual optical functional layer, respectively.

13. The hybrid touch sensing electrode according to claim 1, wherein the first sensing patterns and the second sensing patterns are formed on different planes from each other.

14. The hybrid touch sensing electrode according to claim 1, wherein the first sensing patterns and the second sensing patterns are not provided with additional insulation.

15. The hybrid touch sensing electrode according to claim 1, wherein both of refractive index differences between the first optical functional layer and the first sensing patterns, and between the second optical functional layer and the second sensing patterns are 0.8 or less.

16. The hybrid touch sensing electrode according to claim 1, wherein the sensing patterns have a refractive index of 1.3 to 2.5.

17. A touch screen panel comprising the hybrid touch sensing electrode according to claim 1.

18. The touch screen panel according to claim 17, wherein, when one of the first optical functional layer and the second optical functional layer included in the hybrid touch sensing electrode is a retarder, and an optical functional film is adhered to an upper portion of the retarder by an adhesive agent, a refractive index difference between the sensing patterns formed on an upper side based on the retarder and an upper adhesive agent layer is 0.3 or less.

19. The touch screen panel according to claim 17, wherein, when one of the first optical functional layer and the second optical functional layer included in the hybrid touch sensing electrode is a retarder, and an optical compensation film is adhered to an upper portion of the retarder by an adhesive agent, a refractive index difference between the sensing patterns formed on a lower side based on the retarder and an upper adhesive agent layer is 0.8 or less.

20. The touch screen panel according to claim 17, wherein the touch screen panel is adhered to a flexible display.
